(19) United States
(12) Patent Application Publication
(10) Pub. No.: US 2009/0178386 A1
(43) Pub. Date: Jul. 16, 2009

(54) Aircraft Propulsion System

(76) Inventor: Humberto W. Sachs, Hansville, WA (US)

Correspondence Address: HUMBERTO SACHS, 37644 TEEL LN NE, HANSVILLE, WA, 98340, US

(21) Appl. No.: 12/013,431

(22) Filed: Jan. 12, 2008

(51) Int. Cl. F02K 3/02

(52) U.S. Cl. 60/226.1

(57) ABSTRACT

The invention is a novel aircraft propulsion system architecture that delivers thrust at minimum fuel consumption rates with the side benefits of noise and pollution emission abatement. The invention implements three technologies:
a. Unique turbine nozzle design allowing for a cooling cycle, thus increasing its thermal efficiency.
b. Specific jet-drive design propelling the fan blades allowing for power amplification. At any given shaft velocity, the output torque of a machine is proportional to shaft power. Jet-driven torque is insensitive to velocity. For nozzle velocities greater than 550 fps, there is power amplification (et propulsion principle).
c. Specific exhaust and waste heat regeneration design increasing the fanjet thrust with no additional fuel consumption.

This aircraft propulsion system invention is henceforth called APS.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BRIEF DESCRIPTION OF THE SEVERAL VIEWS OF THE DRAWING

### List of Figures

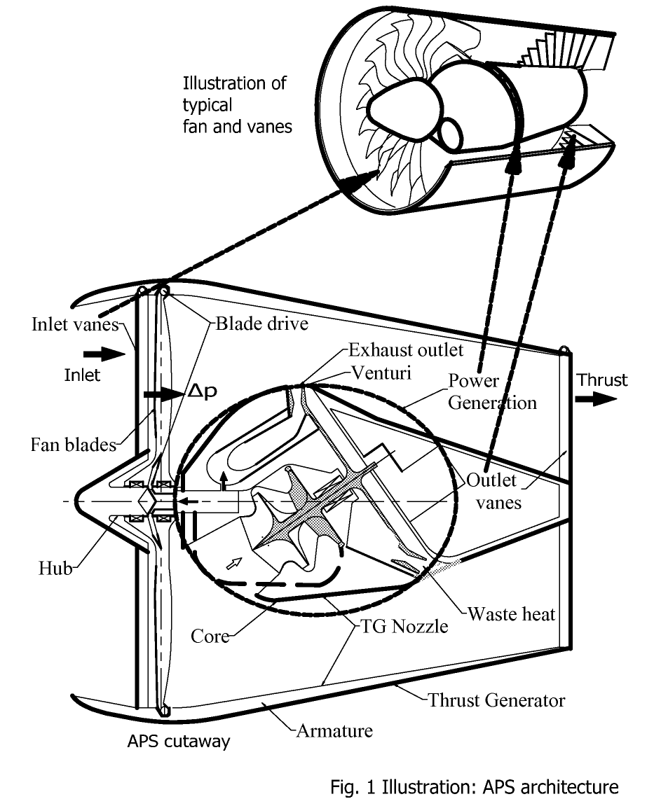

FIG. 1 Illustration: APS architecture

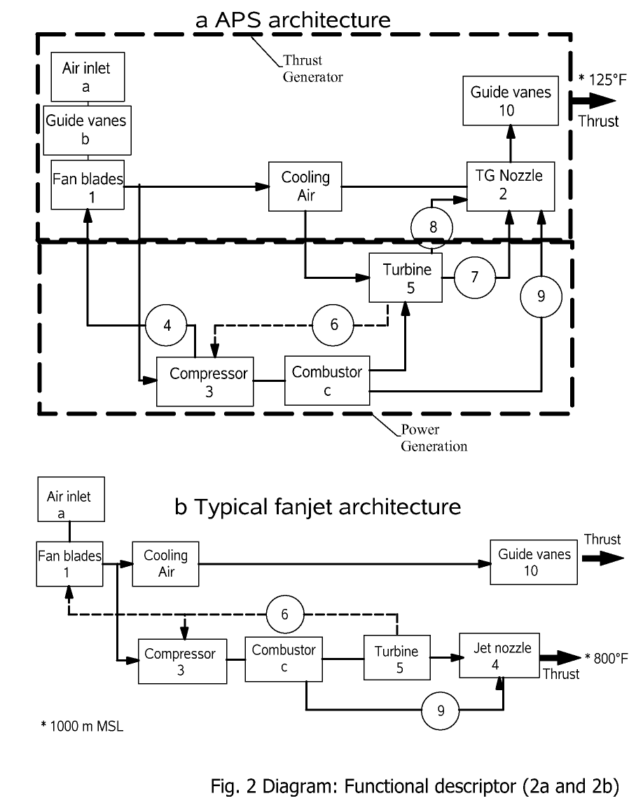

FIG. 2 Diagram: Functional descriptor (2a and 2b)

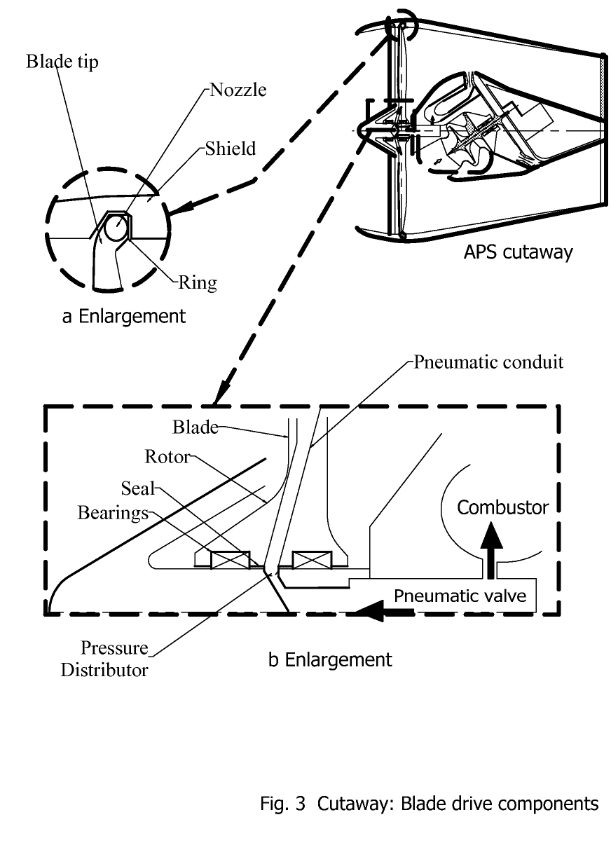

FIG. 3 Cutaway: Blade drive components

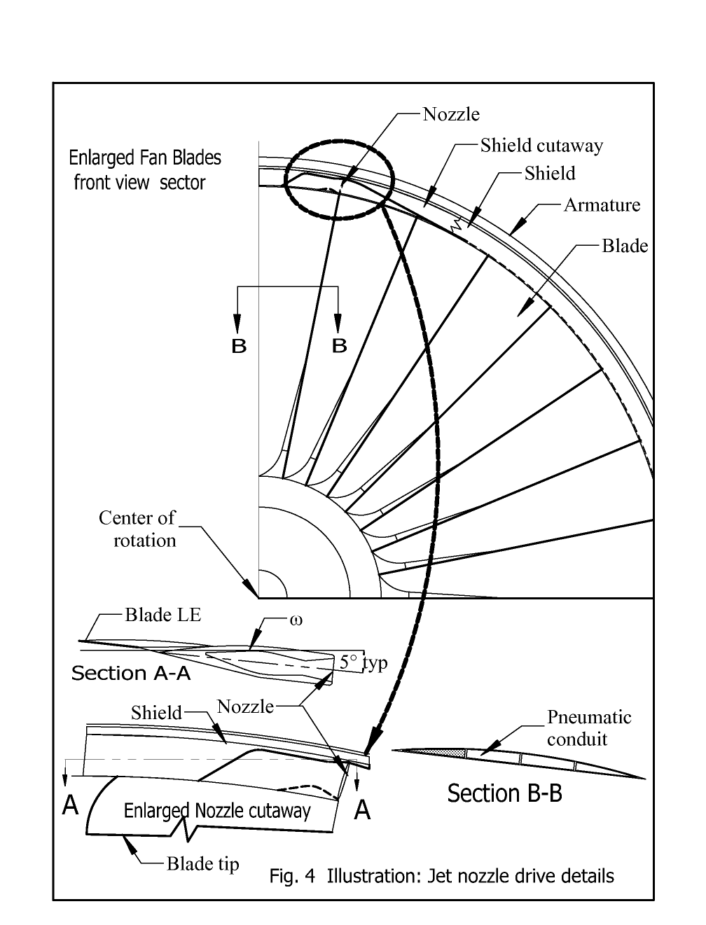

FIG. 4 Illustration: Jet nozzle drive details

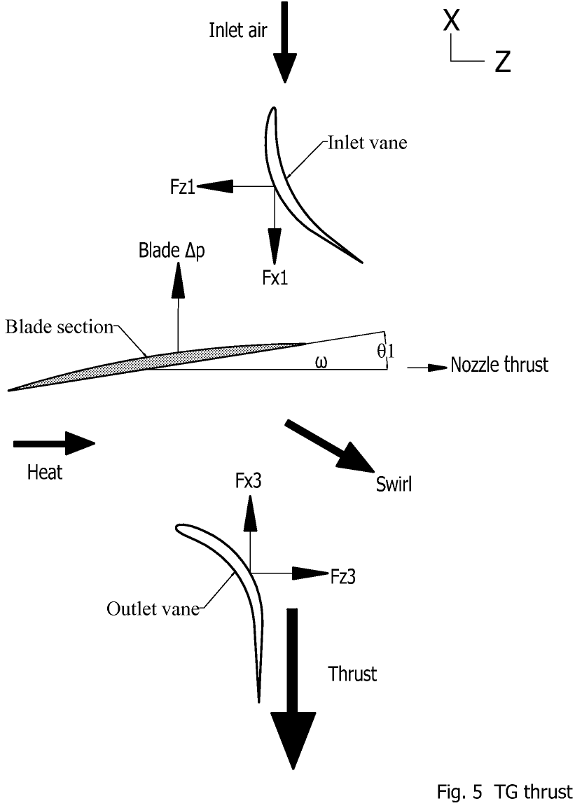

FIG. 5 Diagram: TG thrust

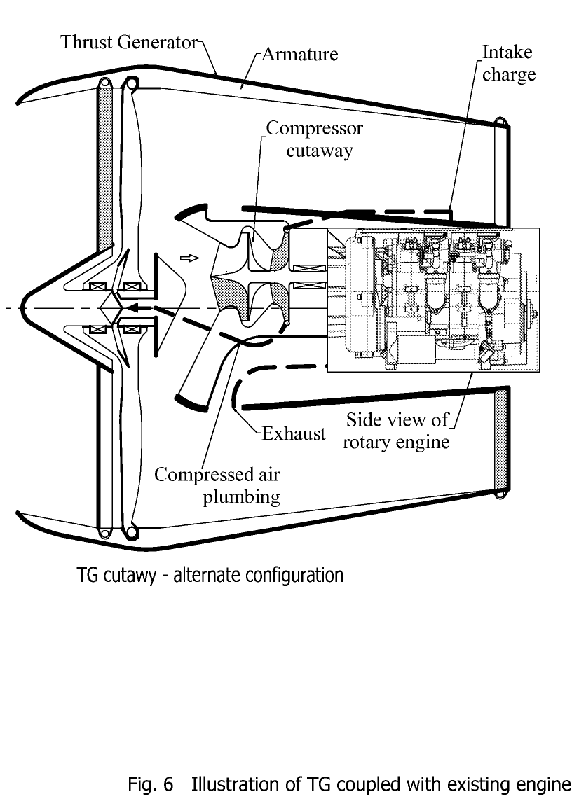

FIG. 6 Illustration of TG coupled with existing turbine

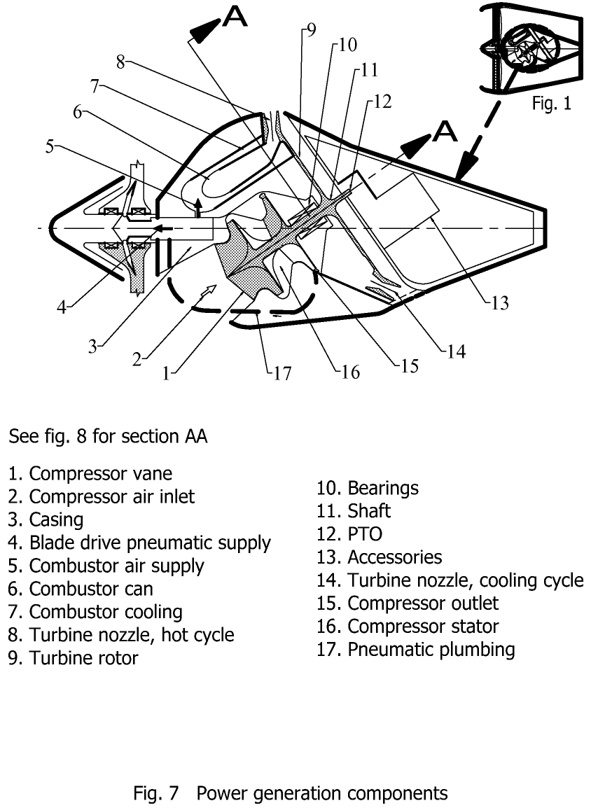

FIG. 7 Power generation components

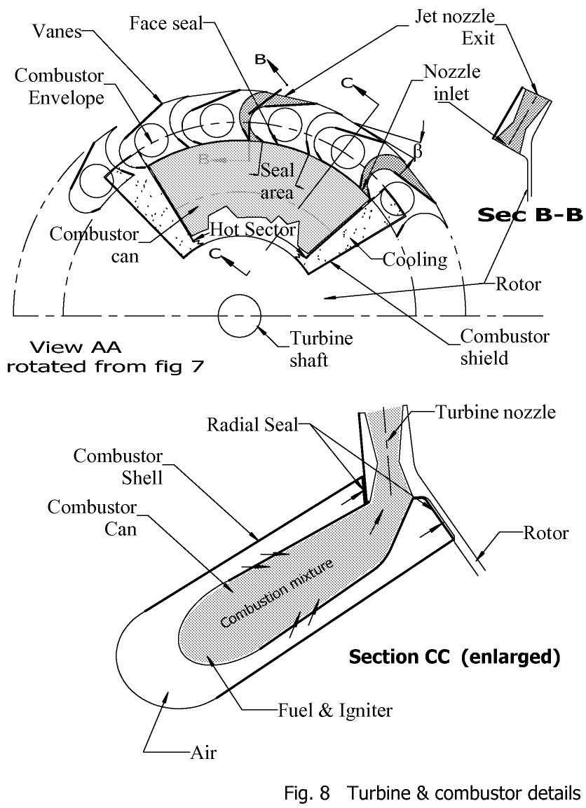

FIG. 8 Turbine & combustor details

### BACKGROUND OF THE INVENTION

The advent of jet engines changed aviation. Now it is clear that fanjet technology is far more efficient than jets. Also, there is a need for clean, quite and fuel efficient propulsion. While aircraft heat regeneration and turbine cooling are long sought thermodynamic goals, the current culture believes turbine architecture to be a physical law. Thirty years of private research leads me to visualize a different architecture. The idea is to create an efficient thrust generator that also works as a super muffler and reuses all waste heat internal engines must exhaust. On the power generation or turbine side, the most significant obstacle to an efficient machine is the temperature limitation dictated by vanes material. While some vane cooling methods exist for ground based turbines, they are not practical for airborne applications. Thus, a radical new design and architecture was necessary to allow the implementation of a cooling cycle, only possible with change of the basic turbine technology. With the APS, combustion temperatures up to 1900° K are feasible. Jet-driven fan blades drive is more efficiently than current shaft-driven design.

Reference Data used for Background Research

With more than 40-year aerospace experience, I am certain that there is absolutely nothing out there that even comes close to the APS architecture. Of course, I am familiar with all existing aircraft propulsion systems and proposed hypersonic future designs.

### BRIEF SUMMARY OF THE INVENTION

The invention is basically an enhanced fanjet aircraft propulsion system with a unique architecture integrating several desirable technologies. It is composed of two major elements, the thrust generator and the power generation. Unique overall functionality is the fact that the entire thrust of the APS is due to the fan-jet, instead of being just a by-pass as established by current culture.

The entire propulsion thrust is generated by air flow spun by inlet vanes and then captured by high speed fan blades inducing further whirling of the air stream. This produces fan-blade absolute velocity far above current technology, thus requiring an alternate driving method, provided by blade tip pneumatic nozzles. Heat exhaust from the turbine is injected via a venturi wall into the whirling air flow, mixing and accelerating the air flow similar to an afterburner. This accelerated air stream is then guided via exit vanes, providing the thrust gain that characterizes the invention.

The power generation key technology is the design of unique vanes that cycle through a hot and cooling sector, allowing the combustion temperature to far exceed current levels, thus increasing the thermal efficiency of the machine. This turbine output is matched to standard compressors, which in turn drives the fan blades via pneumatic nozzles. There is no mechanical interface between the turbines and fan blades.

### OBJECTIVES AND SUMMARY OF THE INVENTION

The embodiment of this invention is to deliver an efficient, fuel and cost effective aircraft propulsion system compared to current fan jet, turbo-prop and other propulsion systems. It is also the goal of this technology to reduce pollution of both, contaminants and noise. The APS may be produced as an integrated system, or a thrust generator coupled with existing engines or free-shaft turbine.

### DETAILED DESCRIPTION OF THE INVENTION

The specific architecture, configuration and functional details composing the embodiment of this invention allows for new aircraft design or the replacement of the propulsion units on existing aircraft to benefit from fuel economy, lower emission of pollutants and noise. The major elements of the invention are the thrust generator (TG) and the power generation modules, as illustrated in FIG. 1.

Referring to the cutaway in FIG. 1, the TG is composed of its armature, inlet guide vanes, fan blades, blade drive, TG nozzle or chamber and outlet guide vanes. It is of essence to notice that the heat entrance into the TG nozzle is via a venturi effect interface. The TG is responsible for the entire thrust of the APS, a most significant departure from today's fanjet design. The fan blades create the typical absolute pressure increase (Δp) and the induced swirl in the propelled air mass in addition to the vortex generated by the inlet guide vanes. This invention total thrust is further discussed with FIG. 5.

The location of the power generation may or may not be integral with the TG as shown in FIG. 1. It is also an essential design feature of this invention that the power generation may be a standard turbine, or any internal combustion engine interconnected via pipes with the TG as shown in FIG. 6.

The inlet vanes are standard design and the only uniqueness relating to this invention is the magnitude of air inlet deflection that is practical to implement for best operation. With standard engines, this feature would impose drag losses. With the APS, it adds to the final thrust as discussed with FIG. 5. While being a structural component supporting the engine hub, the inlet guides are designed to maximize air circulation, reduce the effective blade pitch angle θ1 (FIG. 5) and thus minimize drag losses.

The blade shape corresponds to standard technology, although the implementation of inlet guides will simplify its shape and thus easy of manufacturing. However, the unique blade drive design is also an essence to this invention and further discussed when reviewing FIG. 3. Therefore, this fan blade integrated with its drive composes a specific design that is unique and pertinent to this invention.

Thrust guide or outlet vanes, also a structural component supporting the engine core, are standard technology, except for the degree of air deflection producing the force Fx3 shown in FIG. 5.

The APS diagram in FIG. 2.a shows the power generation module delivering exhaust and waste heat directly into the TG nozzle, voiding heat losses typical of fanjets as shown in FIG. 2.b. The diagram 2.a also shows that the air compressor in the power generation module supplies the combustor and the fan blade nozzle. Therefore, there is no mechanical drive between the turbine and the fan blades. These are essential characteristics of this invention.

Enlargement 3.a (FIG. 3) depicts a pneumatic nozzle installed on the tip of a fan blade enveloped by a structural shield within the TG armature. The system may be equipped with two or more nozzles. The vane tips and the nozzles may be shrouded by a rotating ring. Details of the nozzle are shown in FIG. 4 where the section AA shows the location of the nozzle with respect to the blade section and section BB illustrates the pneumatic pressure conduit within the fan blade. This feature also provides continuous blade de-icing function. The force developed by the nozzle provides the required torque to drive the fan blades and it is insensitive to the blade tip velocity.

The FIG. 3 enlargement 3.b depicts a standard pneumatic valve which supplies compressed air to both, the combustor and the blade nozzle via a pressure distributor. The function of the valve is to assure proper mass rate supply to the combustor allowing the remaining air flow to fill up the distributor chamber from where metered flow enters the blade core. To speed up engine start up, the valve may shut down the flow to the distributor until ignition occurs. The pressure distributor function is to deliver continuous pressurized air to the blade pneumatic conduit. a function that is also an essence to this patent. The illustration depicts the function of the distributor, not a specific design. Many standard combinations of seals and cavities can provide the function, thus this patent does not depends on any specific hardware detail.

Referring to FIG. 4, an enlarged nozzle cutaway shows its basic geometry installed on a blade tip and identifies the origin of section AA. The section AA illustrates the small nozzle angle with the rotation plan ω. Thus, the nozzle exhaust and its heat contents enter the TG chambers behind the leading edge (LE) of the subsequent fan blade. Once more, the detail design of the nozzle is standard technology, therefore, not an element of this patent. What is an essence to this patent is the unique functional arrangement of the nozzle on the blade tip, regardless of detail specific design of its parts.

FIG. 5 maps the thrust function of the TG via a diagram. Since the blade nozzle provides the same torque regardless of blade rotational speed, the invention takes advantage of this jet drive to increase the swirl velocity via the inlet vanes. This results into minimum blade drag due to small pitch angle θ1 while it does produce the drag Fx1. Yet, due to the regeneration of the spin via the outlet vane producing Fx3, there is significant net thrust gain.

The heat addition into the TG chambers increases the swirl velocity which is now captured in terms of the force Fx3, also increasing thrust. While anyone of these functions is well established thermodynamics, the invention unique architecture allows its integration into a most efficient thermodynamic system, easily demonstrated with a specific engine cycle TS diagram. This integration and functional arrangement is of essence of this invention.

The Thrust Generator shown in FIG. 1 may be coupled with a standard turbine or engine as illustrated in FIG. 6. In this alternate configuration, the APS power generation is replaced by an internal combustion engine. The existing engine may be a free shaft turbine delivering compressed air, or it may be any engine coupled with an air compressor.

Referring to FIG. 6, a TG cutaway shows a core interconnected with a standard engine. For small propulsion systems, a rotary engine powering a centrifugal compressor is a practical configuration. In this alternate configuration, the compressor powers the fan-blades and charges the engine intake via a control gate. It is also practical to increase the engine inlet pressure although the fuel injection must be greater than stoichiometric mixture. This extra fuel injection method of combustion chamber cooling is not fuel efficient, except that in the APS the additional fuel burns while mixing in the TG, thus not wasted. This is another functional enhancement typical of this invention characteristic. The actual exhaust plumbing and injection point may be various, including the possibility of entering the TG via the armature wall.

While this configuration does not benefit from the APS turbine efficiency, it is a viable and effective implementation of this invention resulting in significant fuel savings. All the benefits of the heat regeneration and the blade drive amplifications are readily realized with this alternate configuration.

As shown in FIG. 1, the power generation module in the integrated APS is located in its core. Referring to FIG. 7, an enlarged view of the core cutaway illustrates its components. While the drawing depicts a mixed flow, dual stage centrifugal compressor (item 1, 11 and 15), the design is not limited to the configuration shown. The intent of the illustration is to confirm that the turbine (9) and the compressor stages are mechanically coupled and may be supported by common bearings (10). Also, the intent is to illustrate that the high speed rotating equipment needs not to be on the center line of the core. Actually, any arrangement that will allow the turbine hot cycle (8) to enter the TG chambers via a venturi wall is within the domain of this invention. This also means that the turbine, mounted on its own bearings, may be interconnected with the compressors via reduction gears, allowing for the best turbine speed and also the best compressor angular rotation. Inherent in this invention architecture, such flexibility is another essence to this invention.

For functional depiction purposes, the plumbing (17) is shown cutting across the compressor inlet. In reality, such plumbing would be on a radial offset avoiding the compressor air inlet area.

Since the specific design of compressors is standard technology, it needs not to be discussed here. However, the unique turbine with its cooling cycle is new technology of essence to this invention, requiring also a unique combustor design. The cooling cycle of the turbine allows for greater combustion temperature than existing technology, with significant fuel economy advantages.

Referring to FIG. 8, AA is a true view of a sector of the turbine, as defined in FIG. 7. FIG. 7 shows a cutaway of the turbine including the turbine nozzle (8), the turbine rotor (9) and its shaft (11) which drives the compressors. The view AA in FIG. 8 depicts a cascade of jet nozzles with a significant sealing surface between each nozzle inlet, called face seal. The purpose of the face seal is to minimize the pressure losses during the nozzle approach to and exit from the combustor hot sector. Because of the known deficiency of turbine blades designed for hot/cool cycling, this sealing functional detail is also an essence to this invention. The actual sealing surface is designed in accordance with standard practice for dynamic seals.

The vane's cascade creates the geometry of the jet nozzles in between them. It should be observed that the nozzle inlet is at a smaller diameter on the rotation plan than the exit, allowing for two characteristics: 1) The radius is sized for the desirable inlet air speed and 2) the outlet radius combined with the geometry inherent of large face seal arch allows designing for minimum β angle, thus optimizing the turbine output. For clarity, FIG. 8 shows a larger than needed β angle.

While the illustration shows only four nozzles active at anyone time, the number of nozzles exposed to the hot sector may vary. The invention is not limited to the shown hot sector size or size of the jet nozzles. It is also practical to have two hot zones with the implementation of two combustors. The illustration intends to depict the turbine fundamental function provided by the invention: a unique nozzle design separated by face seal sectors providing an effective way to create a turbine hot cycle and a cooling cycle. In this invention, the traditional fluid dynamics of continuous flow around vanes is replaced with the technology of a plenum (the hot sector) supplying hot gases to independent nozzles as they cross the plenum threshold.

Section CC of FIG. 8 is actually an enlargement of FIG. 7, items 6,7 and 8. It depicts the combustor shell interfacing with the radial seals, which complements the face seal. The general design of the combustor can is industry standard, except for its geometry to fit inside the combustor shell, which is unique to provide the hot cycle sector and the mentioned seal surfaces.

What is claimed and desired to be secured by Letters Patent of the United States is the invention of a unique Aircraft Propulsion System. The uniqueness of this invention is embodied in the APS architecture, configuration and functional integration providing the user with the benefit of fuel economy combined with lower emission of pollutants and noise. Furthermore, the thrust generator is responsible for the entire thrust of the APS, a most significant departure from today's fanjet design. In addition, the architecture flexibility separating the thrust generator from the power generation allows for the design of aircraft configurations restricted by current engine design. This invention may be installed in existing or incorporated into new aircraft design.

1. Therefore, I claim that the thrust generator output is enhanced by the fan blade pneumatic drive, the inlet air spin generation and the ability to regenerate turbine and waste heat, in accordance with the claim stated in paragraph 13.
a. The unique installation of pneumatic nozzle on the tip of fan blade, being fed by pneumatic pressure transported within the blade from a core distributor, is an essence to this invention.
b. Inlet guide vanes deflecting the air stream to achieve high spin velocities allows greater than current technology fan blade absolute speeds for a given torque, imposing the amplification obtainable only with jet-driven torque which is independent of blade RPM.
c. Injection of turbine exhaust directly into the whirling air stream in the generator chamber via a venturi wall is also unique and an essence to this invention.
I also claim that the APS power generator requires substantially less fuel than current technology because of the unique design of its vanes, cooling cycle and combustor interface, in accordance with the claim stated in paragraph 13.
a. While the turbine directly drives the air compressors, it has no mechanical interface with the fan blades in this unique invention architecture, thus allowing for best turbine and compressor matching, possibly reducing complexity, weight and cost as compared to current culture.
b. The detail design of the cascade vanes, unique to this invention, creates nozzles and a necessary seal between the turbine and combustor, making it practical to implement a cooling cycle. This feature is also an essence to this invention.
